(19) United States
(12) Patent Application Publication
(10) Pub. No.: US 2022/0274882 A1
(43) Pub. Date: Sep. 1, 2022

(54) INFRARED SELECTIVE RADIATION COOLING NANO-FUNCTIONAL COMPOSITION AND PREPARATION METHOD THEREOF

(71) Applicant: NANJING TECH UNIVERSITY, Nanjing, Jiangsu (CN)

(72) Inventors: Chunhua LU, Nanjing (CN); Yaru NI, Nanjing (CN); Zhenggang FANG, Nanjing (CN); Zhongzi XU, Nanjing (CN)

(73) Assignee: NANJING TECH UNIVERSITY, Nanjing, Jiangsu (CN)

(21) Appl. No.: 17/631,071

(22) PCT Filed: Apr. 14, 2020
(86) PCT No.: PCT/CN2020/084640

§ 371 Date: Jan. 28, 2022

(30) Foreign Application Priority Data
Jul. 30, 2019 (CN) 201910695003.4

(51) Int. Cl. C04B 35/14; C04B 35/495; C04B 35/16; C04B 35/626; G02B 5/20

(52) U.S. Cl. CPC C04B 35/14; C04B 35/495; C04B 35/16; C04B 35/6264; C04B 35/62615; G02B 5/208; G02B 5/206; C04B 2235/3418; C04B 2235/3427; C04B 2235/3256; C04B 2235/5454; G02B 2207/101

(57) ABSTRACT

An infrared selective radiation cooling nano-functional composition and a preparation method thereof, wherein the composition is prepared from silica, a rare earth silicate compound and a molybdate compound according to a mass ratio of 1:(0.5-2):(0.5-2) by ball milling and uniform mixing, and the silica, the rare earth silicate compound and the molybdate compound have high infrared selective radiation performance at 8-10 μm, 9-12 μm and 10-14 μm. The rare earth silicate and molybdate compound are prepared by a sol-gel and a high-temperature solid phase process according to stoichiometric ratios SiO₂-(0.5-2)Re₂O₃-(0.1-1.0)Na₂O (Re═La, Sm, Eu, Gd, Tb, Dy, Er, Tm, Yb, Y or Sc) and RMoO₄ (R═Mg, Ca, Sr or Ba). The infrared selective radiation cooling nano-functional composition prepares functional devices such as day and night double-effect radiation coolers to provide zero-energy cooling, energy saving and efficiency improvement functions for buildings, grain and oil stores, solar battery back plates and the like.

### BACKGROUND

### Technical Field

The present invention belongs to the technical field of heat radiation, and relates to an infrared selective radiation cooling nano-functional composition and a preparation method thereof.

### Related Art

With rapid development of global economy, the energy crisis problem becomes more and more prominent, air conditioning cooling accounts for a considerable proportion in energy consumption, and therefore, development of an efficient radiation cooling technology has a great significance for reducing power consumption and protecting the environment. Radiation cooling refers to a process in which objects on the earth transfer heat to the outer space through an infrared atmospheric window, and radiation cooling materials having spontaneous cooling functions are prepared based on this principle. In a heat transfer process, the atmosphere is a main transmission medium for infrared radiation. Although the atmosphere is transparent to visible light, a large part of infrared radiation cannot pass through the atmosphere in an infrared band. This is because polyatomic gas molecules such as H₂O, CO₂, O₃ and CH₄ in the atmosphere cause changes of electric dipole moment of molecules during transmission of infrared radiation, leading to absorption or scattering of infrared radiation, and in the actual atmosphere, many suspended solids or liquids such as smoke, fog, rain, snow and dust will also hinder transmission of infrared radiation. It is found through researches on atmospheric transmissivity that many gas molecules have low absorption in a band of 8-14 μm, and infrared radiation can pass through the atmosphere and spread far away, so that this area is called an “atmospheric window.”

In a sunlight environment, heat exchange of a radiation cooler during operation mainly includes the following terms: first, absorbed solar radiation; second, absorption of infrared radiation in the atmosphere; third, infrared radiation discharged through an infrared window; and fourth, heat convection and conduction in natural air. In order to achieve the best passive cooling effect, radiation cooling materials need to have a high emissivity in an infrared band of 8-14 μm and a high reflectivity in a solar spectrum band of 0.38-2.5 μm. A radiation cooler usually includes an infrared radiation layer and a sunlight reflection layer. The infrared radiation layer is used to discharge heat of an object to the space through an infrared atmospheric window, and the sunlight reflection layer is used to efficiently reflect sunlight and reduce heat absorption of sunlight.

At present, radiation coolers used at night without sunlight irradiation have been developed, but high-performance radiation coolers meeting practical performance requirements under daylight irradiation conditions have not been prepared yet. Existing publicly reported radiation coolers are mainly prepared by the following methods: one method refers to use of a photoetching technology and a nano plasma deposition technology to construct a nano-structured radiation cooler, and a photon radiation cooler with such structure is high in cost, cannot be produced in a large scale and is low in structural strength, likely to be damaged and poor in long-term stability. The other method refers to composite bonding of polymers and inorganic functional substances such as titanium dioxide and glass microspheres to a highly reflective metal substrate to obtain a radiation cooler. However, since the absorption selectivity of the functional substances such as titanium dioxide and glass microspheres in an infrared spectral region is low, a prepared radiation cooler has high absorptivity and emissivity in a non-infrared atmospheric window outside a range of 8-14 μm, and is poor in selective radiation ability and likely to absorb a large amount of additional atmospheric heat radiation from the environment. Therefore, the cooling effect of the whole radiation cooler is reduced, and the effective cooling power is not satisfactory. At present, an infrared selective radiation cooling nano-functional composition which can meet functional requirements of day and night double-effect radiation coolers and be manufactured in a large scale and at a low cost, and a preparation process thereof have not been reported yet.

### SUMMARY

An objective of the present invention is to provide an infrared selective radiation cooling nano-functional composition which can solve the problems in the prior art. Another objective of the present invention is to provide a preparation method of the infrared selective radiation cooling nano-functional composition.

In order to achieve the objectives above, the present invention is achieved through the following technical solutions: an infrared selective radiation cooling nano-functional composition. The infrared selective radiation cooling nano-functional composition is prepared from nano-silica, a rare earth silicate compound and a molybdate compound according to a mass ratio of 1:(0.5-2):(0.5-2) by ball milling and uniform mixing, wherein the nano-silica has high infrared selective radiation performance at 8-10 μm (infrared radiation absorption coefficient higher than 0.8); the rare earth silicate compound meets a stoichiometric ratio SiO₂-(0.5-2)Re₂O₃-(0.1-1.0)Na₂O and has high infrared selective radiation performance at 9-12 μm (infrared radiation absorption coefficient higher than 0.8), wherein Re is La, Sm, Eu, Gd, Tb, Dy, Er, Tm, Yb, Y or Sc; the molybdate compound meets a stoichiometric ratio RMoO₄ and has high infrared selective radiation performance at 10-14 μm (infrared radiation absorption coefficient higher than 0.8), wherein R is Mg, Ca, Sr or Ba.

More preferably, the rare earth silicate compound is SiO₂-(0.5-2.0)Re₂O₃-(0.1-1.0)Na₂O, and RE is any one or a combination of La, Gd, Tm, Y and Sc, more preferably any one or a combination of La, Gd and Y.

The molybdate compound meets a stoichiometric ratio RMoO₄, and R is preferably any one or a combination of Mg and Ca.

The nano-functional composition has high selective absorption-radiation performance in an atmospheric window of 8-14 μm and is transparent to ultraviolet-visible-near infrared sunlight.

The present invention also provides a preparation method of the infrared selective radiation cooling nano-functional composition, specifically including the following steps:

(a) accurately weighing nano-silica, rare earth nitrate and sodium nitrate according to a stoichiometric ratio of a rare earth silicate compound, mixing and dispersing into an ethanol-water mixed solution; evaporating a solvent in a water bath under stirring to obtain a gel; presintering the gel at a low temperature of 120-150° C. for 3-6 hours, and then thermally heating at 600-900° C. for 3-12 hours to obtain a rare earth silicate compound;

(b) accurately weighing ammonium molybdate and alkaline earth metal nitrate according to a stoichiometric ratio of a molybdate compound and dissolving in deionized water; preparing a citric acid solution, adding dropwise into the solution above and stirring vigorously, adjusting the pH to 3.0-4.0, and evaporating a solvent in a water bath under stirring to obtain a gel; presintering the gel at a low temperature of 120-150° C. for 3-6 hours, and then thermally heating at 800-1000° C. for 3-12 hours to obtain a molybdate compound;

(c) weighing a certain amount of nano-silica, the rare earth silicate compound and the molybdate compound according to a mass ratio of a nano-functional composition, and processing by using a high-speed grinding and dispersing machine to obtain an infrared selective radiation cooling nano-functional composition.

Preferably, a temperature of the water bath in step (a) is 70-80° C. Preferably, a mass concentration of the citric acid solution in step (b) is 5%-10%; the pH is adjusted with ammonia water; a temperature of the water bath is 70-80° C. Preferably, a rotation speed of the high-speed grinding and dispersing machine in step (c) is 300-400 r/min, and the processing time is 2-6 hours.

### BENEFICIAL EFFECTS

According to the present invention, the nano-silica having high infrared selective radiation performance at 8-10 μm, the rare earth silicate compound having high infrared selective radiation performance at 9-12 μm and the molybdate compound having high infrared selective radiation performance at 10-14 μm are compounded to obtain the nano-functional composition which is transparent to ultraviolet-visible-near-infrared sunlight and has high infrared selective radiation cooling characteristics in an infrared atmospheric window of 8-14 μm, the technical difficulty in low-cost and large-scale manufacturing of high-performance day and night double-effect radiation coolers, autonomous radiation cooling coatings and the like is reduced, and a new technical approach is provided for realizing zero-energy cooling, large-scale energy saving and efficiency improvement of buildings, grain and oil stores, high-power electronic equipment, refrigerators and the like.

### BRIEF DESCRIPTION OF THE DRAWINGS

FIG. 1 is an infrared selective absorption/radiation spectrum of Embodiment 1.

### DETAILED DESCRIPTION

In order to better understand the present invention, the following embodiments are specifically given to illustrate the present invention in detail, but not used to limit the content of the present invention. With deepening of description, the advantages and features of the present invention become clearer, but are not used as a basis for limiting the present invention. After reading the present invention, those skilled in the art should understand that modifications or replacements of the present invention in various equivalent forms still fall within the protection scope of the present invention.

### Embodiment 1

The embodiment discloses an infrared selective radiation cooling nano-functional composition and a preparation process thereof, and the preparation process includes the following steps:

(a) 30 g of nano-silica (50 nm, commercially available), 324.9 g of lanthanum nitrate and 85 g of sodium nitrate are accurately weighed according to a stoichiometric ratio SiO₂—La₂O₃-0.5Na₂O of a rare earth lanthanum silicate compound and dissolved in an ethanol-water mixed solution, a solvent is evaporated in a water bath under stirring at 70° C. to obtain a gel, and the gel is thermally treated at 120° C. for 6 hours to obtain rare earth lanthanum silicate presintered powder which is then thermally treated at 700° C. for 12 hours to obtain a rare earth lanthanum silicate compound with an average particle size of 106 nm.

(b) 82 g of calcium nitrate and 170 g of ammonium dimolybdate are accurately weighed according to a chemical formula CaMoO₄ of calcium molybdate and dissolved in deionized water. An 8% citric acid solution is prepared, added dropwise into the solution above and stirred vigorously, the pH is adjusted to 3.5 with ammonia water, a solvent is evaporated in a water bath under stirring at 70° C. to obtain a gel, and the gel is thermally treated at 150° C. for 6 hours to obtain calcium molybdate presintered powder which is then thermally treated at 900° C. for 6 hours to obtain calcium molybdate with an average particle size of 103 nm.

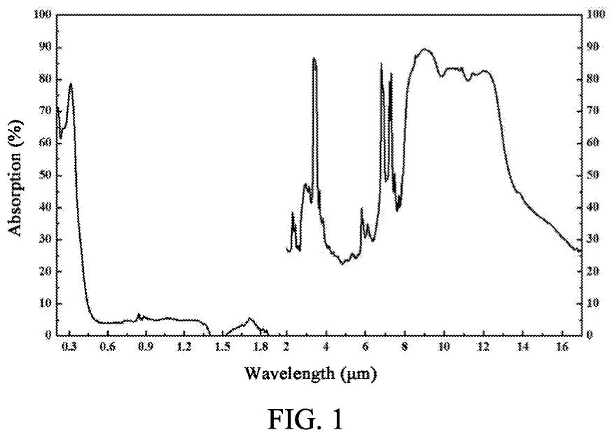

(c) 40 g of nano-silica (50 nm, commercially available), 40 g of the rare earth lanthanum silicate compound in step (a) and 40 g of the calcium molybdate in step (b) are separately weighed according to a weight ratio 1:1:1 of a functional powder composition and added into a ball milling tank of a high-speed grinding and dispersing machine for ball milling at a rotation speed of 300 r/min for 6 hours to obtain a required infrared selective radiation cooling nano-functional composition, and the highest absorption/emissivity of the nano-functional composition in an infrared wavelength range of 8-14 μm is 0.90. An infrared selective absorption/radiation spectrum of the nano-functional composition is as shown in FIG. 1.

### Embodiment 2

The embodiment discloses an infrared selective radiation cooling nano-functional composition and a preparation process thereof, and the preparation process includes the following steps:

(a) 24 g of nano-silica (50 nm, commercially available), 134.5 g of samarium nitrate and 42.5 g of sodium nitrate are accurately weighed according to a stoichiometric ratio SiO₂-1.5Sm₂O₃-0.25Na₂O of a rare earth lanthanum silicate compound and dissolved in an ethanol-water mixed solution, a solvent is evaporated in a water bath under stirring at 70° C. to obtain a gel, and the gel is thermally treated at 150° C. for 3 hours to obtain rare earth lanthanum silicate presintered powder which is then thermally treated at 900° C. for 3 hours to obtain a rare earth lanthanum silicate compound with an average particle size of 115 nm.

(b) 72.2 g of magnesium nitrate and 85 g of ammonium dimolybdate are accurately weighed according to a chemical formula MgMoO₄ of calcium molybdate and dissolved in deionized water. A 10% citric acid solution is prepared, added dropwise into the solution above and stirred vigorously, the pH is adjusted to 3.0 with ammonia water, a solvent is evaporated in a water bath under stirring at 80° C. to obtain a gel, and the gel is thermally treated at 120° C. for 6 hours to obtain calcium molybdate presintered powder which is then thermally treated at 1000° C. for 3 hours to obtain calcium molybdate with an average particle size of 103 nm.

(c) 40 g of nano-silica (50 nm, commercially available), 60 g of the rare earth lanthanum silicate compound in step (a) and 15 g of the calcium molybdate in step (b) are separately weighed according to a weight ratio 1:1.5:0.5 of a functional powder composition and added into a ball milling tank of a high-speed grinding and dispersing machine for ball milling at a rotation speed of 350 r/min for 4 hours to obtain a required infrared selective radiation cooling nano-functional composition, and the highest absorption/emissivity of the nano-functional composition in an infrared wavelength range of 8-14 μm is 0.89.

### Embodiment 3

The embodiment discloses an infrared selective radiation cooling nano-functional composition and a preparation process thereof, and the preparation process includes the following steps:

(a) 30 g of nano-silica (30 nm, commercially available), 487.4 g of lanthanum nitrate and 42.5 g of sodium nitrate are accurately weighed according to a stoichiometric ratio SiO₂-1.5La₂O₃-0.5Na₂O of a rare earth lanthanum silicate compound and dissolved in an ethanol-water mixed solution, a solvent is evaporated in a water bath under stirring at 80° C. to obtain a gel, and the gel is thermally treated at 120° C. for 6 hours to obtain rare earth lanthanum silicate presintered powder which is then thermally treated at 650° C. for 12 hours to obtain a rare earth lanthanum silicate compound with an average particle size of 94 nm.

(b) 82 g of calcium nitrate and 170 g of ammonium dimolybdate are accurately weighed according to a chemical formula CaMoO₄ of calcium molybdate and dissolved in deionized water. An 8% citric acid solution is prepared, added dropwise into the solution above and stirred vigorously, the pH is adjusted to 4.0 with ammonia water, a solvent is evaporated in a water bath under stirring at 70° C. to obtain a gel, and the gel is thermally treated at 150° C. for 3 hours to obtain calcium molybdate presintered powder which is then thermally treated at 900° C. for 3 hours to obtain calcium molybdate with an average particle size of 90 nm.

(c) 35 g of nano-silica (50 nm, commercially available), 17.5 g of the rare earth lanthanum silicate compound in step (a) and 70 g of the calcium molybdate in step (b) are separately weighed according to a weight ratio 1:0.5:2 of a functional powder composition and added into a ball milling tank of a high-speed grinding and dispersing machine for ball milling at a rotation speed of 300 r/min for 6 hours to obtain a required infrared selective radiation cooling nano-functional composition, and the highest absorption/emissivity of the nano-functional composition in an infrared wavelength range of 8-14 μm is 0.91.

### Embodiment 4

The embodiment discloses a preparation method of a high-selectivity photon radiation cooler, and the preparation method includes the following steps:

(a) 30 g of nano-silica, 162.5 g of lanthanum nitrate, 34.3 g of gadolinium nitrate and 85 g of sodium nitrate are accurately weighed according to a stoichiometric ratio SiO₂-0.5La₂O₃-0.1Gd₂O₃-1.0Na₂O of rare earth dysprosium silicate and dissolved in a certain volume of an ethanol-water mixed solution, a solvent is evaporated in a water bath under stirring at 70° C. to obtain a gel, and the gel is thermally treated at 150° C. for 3 hours to obtain rare earth dysprosium silicate presintered powder which is then thermally treated at 750° C. for 10 hours to obtain a rare earth dysprosium gadolinium silicate compound with an average particle size of 120 nm.

(b) 41 g of calcium nitrate and 85 g of ammonium dimolybdate are accurately weighed according to a chemical formula CaMoO₄ of calcium molybdate and dissolved in deionized water. A 5% citric acid solution is prepared, added dropwise into the solution above and stirred vigorously, the pH is adjusted to 4.0 with ammonia water, a solvent is evaporated in a water bath under stirring at 80° C. to obtain a gel, and the gel is thermally treated at 150° C. for 4 hours to obtain calcium molybdate presintered powder which is then thermally treated at 850° C. for 12 hours to obtain calcium molybdate with an average particle size of 85 nm.

(c) 28 g of nano-silica (50 nm, commercially available), 56 g of the rare earth dysprosium gadolinium silicate compound in step (a) and 42 g of the calcium molybdate in step (b) are separately weighed according to a weight ratio 1:2:1.5 of a functional powder composition and added into a ball milling tank of a high-speed grinding and dispersing machine for ball milling at a rotation speed of 300 r/min for 6 hours to obtain a required infrared selective radiation cooling nano-functional composition, and the highest absorption/emissivity of the nano-functional composition in an infrared wavelength range of 8-14 μm is 0.92.

What is claimed is:

1. An infrared selective radiation cooling nano-functional composition, prepared from nano-silica, a rare earth silicate compound and a molybdate compound according to a mass ratio of 1:(0.5-2):(0.5-2) by ball milling and uniform mixing, wherein the rare earth silicate compound meets a stoichiometric ratio SiO₂-(0.5-2)Re₂O₃-(0.1-1.0)Na₂O and has high infrared selective radiation performance at 9-12 μm, and Re is La, Sm, Eu, Gd, Tb, Dy, Er, Tm, Yb, Y or Sc; the molybdate compound meets a stoichiometric ratio RMoO₄ and has high infrared selective radiation performance at 10-14 μm, and R is Mg, Ca, Sr or Ba.

2. The infrared selective radiation cooling nano-functional composition according to claim 1, wherein the nano-functional composition has high selective absorption-radiation performance in an atmospheric window of 8-14 μm and is transparent to ultraviolet-visible-near infrared sunlight.

3. A preparation method of the infrared selective radiation cooling nano-functional composition according to claim 1, specifically comprising the following steps:
(a) accurately weighing nano-silica, rare earth nitrate and sodium nitrate according to a stoichiometric ratio of a rare earth silicate compound, mixing and dispersing into an ethanol-water mixed solution; evaporating a solvent in a water bath under stirring to obtain a gel; presintering the gel at a low temperature of 120-150° C. for 3-6 hours, and then thermally heating at 600-900° C. for 3-12 hours to obtain a rare earth silicate compound;
(b) accurately weighing ammonium molybdate and alkaline earth metal nitrate according to a stoichiometric ratio of a molybdate compound and dissolving in deionized water; preparing a citric acid solution and adding dropwise into the solution above, adjusting the pH to 3.0-4.0, and evaporating a solvent in a water bath under stirring to obtain a gel; presintering the gel at a low temperature of 120-150° C. for 3-6 hours, and then thermally heating at 800-1000° C. for 3-12 hours to obtain a molybdate compound;
(c) weighing a certain amount of nano-silica, the rare earth silicate compound and the molybdate compound according to a mass ratio of a nano-functional composition, and processing by using a high-speed grinding and dispersing machine to obtain an infrared selective radiation cooling nano-functional composition.

4. The method according to claim 3, wherein a temperature of the water bath in step (a) is 70-80° C.

5. The method according to claim 3, wherein a mass concentration of the citric acid solution in step (b) is 5%-10%; the pH is adjusted with ammonia water; a temperature of the water bath is 70-80° C.

6. The method according to claim 3, wherein a rotation speed of the high-speed grinding and dispersing machine in step (c) is 300-400 r/min, and the processing time is 2-6 hours.
